(19) United States
(12) Patent Application Publication
(10) Pub. No.: US 2012/0293725 A1
(43) Pub. Date: Nov. 22, 2012

(54) LIGHTING DEVICE, DISPLAY DEVICE AND TELEVISION RECEIVER

(75) Inventor: Yoshiki Takata, Osaka-shi (JP)

(73) Assignee: Sharp Kabushiki Kaisha, Osaka-shi, Osaka (JP)

(21) Appl. No.: 13/519,394

(22) PCT Filed: Dec. 2, 2010
(86) PCT No.: PCT/JP2010/071544

§ 371 Date: Jun. 27, 2012

(30) Foreign Application Priority Data
Jan. 7, 2010 (JP) 2010-001963

(51) Int. Cl. G02F 1/13357; F21V 9/14; H04N 5/66; F21V 13/02

(52) U.S. Cl. 348/739; 362/606; 362/19; 362/602; 349/62; 348/E05.133

(57) ABSTRACT

An object of the present invention is to provide a lighting device that can suppress uneven brightness. Another object of the present invention is to provide a display device and a television receiver each including the lighting device. The lighting device according to the present invention includes an LED 22 having a light emitting surface 22A, a light guide plate 50 having a light entrance surface 50D and a light exit surface 50A, and an optical member 40 arranged to cover the light exit surface 50A. Light emitted from the light emitting surface 22A enters the light entrance surface 50D facing the light emitting surface 22A. The light in the light guide plate 50 exits through the light exit surface 50A. The optical member 40 is arranged such that a light-source-side side surface 41A to 43A of the optical member 40 is located farther from the light guide plate 50 than the light emitting surface 22A of the LED 22.

### TECHNICAL FIELD

The present invention relates to a lighting device, a display device and a television receiver.

### BACKGROUND ART

In recent years, a thin display element, such as a liquid crystal panel and a plasma display panel, is used as a display element of an image display device. This enables the image display device to have a reduced thickness. When the liquid crystal panel is used as the display element, the liquid crystal panel requires a lighting device (backlight device) as a separate lighting device, because the liquid crystal panel does not emit light.

One example of a lighting device is described in Patent Document 1. The lighting device described in Patent Document 1 includes a plurality of light sources (LEDs, for example) arranged on an side end portion (side edge) of the lighting device, and a light guide plate through which the light emitted from the light sources exits toward a display surface of the liquid crystal panel. The light sources are arranged so as to face a light entrance surface of the light guide plate. The light that enters through the light entrance surface is totally reflected repeatedly within the light guide plate, so that the light is guided and then exits from the light exit surface. In addition, a lighting device further including an optical member, such as a light diffuser sheet and a prism sheet, is well known. The optical member is arranged so as to cover the light exit surface of the light guide plate.

### RELATED ART DOCUMENT

### Patent Document

Patent Document 1: Japanese Unexamined Patent Publication No. 2007-293339

### Problem to be Solved by the Invention

In the above-described lighting device including the optical member arranged to cover the light exit surface of the light guide plate, the light emitted from the light source may enter the optical member through a side surface close to the light source in some cases. When the light enters the optical member through the side surface, the light is totally reflected repeatedly and guided to an inner side of the lighting device. As a result, the light guided within the optical member exits locally from the light exit surface of the lighting device. Thus, uneven brightness may occur.

### DISCLOSURE OF THE PRESENT INVENTION

The present invention was accomplished in view of the above circumstances. It is an object of the present invention to provide a lighting device that can suppress uneven brightness. It is another object of the present invention to provide a display device and a television receiver each including the lighting device.

### Means for Solving the Problem

To solve the above problem, a lighting device according to the present invention includes a light source having a light emitting surface, a light guide plate having a light entrance surface and a light exit surface, and an optical member arranged to cover the light exit surface. The light entrance surface faces the light emitting surface of the light source and through which light emitted from the light source enters the light guide plate. The light in the light guide plate exits through the light exit surface. The optical member is arranged such that a light-source-side side surface of the optical member is located farther from the light guide plate than the light emitting surface of the light source.

According to the present invention, the light-source-side side surface of the optical member is located farther from the light guide plate than the emitting surface of the light source. With this configuration, the light emitted from the light emitting surface is less likely to enter the optical member through the light-source-side side surface of the optical member. Accordingly, the light entered the optical member from the light-source-side side surface is less likely to be guided in the optical member. This suppresses that the guided light appears locally on the light exit surface of the lighting device. Thus, uneven brightness is less likely to occur.

In the above configuration, the lighting device may further include a light source board on which the light source is mounted. The light source board is located farther from the light guide plate than the light emitting surface of the light source. The optical member is arranged such that a light-source-side end portion of the optical member overlaps with the light source board in a plan view.

The optical member may include a light diffuser.

The optical member may include a prism sheet.

The optical member may include a reflection-type polarizing sheet.

The light source may be a light emitting diode. This reduces power consumption.

Next, to solve the above problem, a display device according to the present invention includes the above lighting device and a display panel configured to provide display using light from the lighting device.

An example of the display panel is a liquid crystal panel. Such a display device as a liquid crystal display device has a variety of applications, such as a television display or a display of desktop personal computer. Particularly, it is suitable for a large screen display.

Next, to solve the above problem, a television receiver according to the present invention includes the above display device.

### Advantageous Effect of the Invention

According to the present invention, a lighting device that can suppress uneven brightness, a display device and a television receiver each including the lighting device can be provided.

### BRIEF DESCRIPTION OF THE DRAWINGS

FIG. 1 is an exploded perspective view illustrating a general configuration of a television receiver according to a first embodiment of the present invention;

FIG. 2 is an exploded perspective view illustrating a general configuration of a liquid crystal display device included in the television receiver illustrated in FIG. 1;

FIG. 3 is a cross-sectional view of the liquid crystal display device taken along a short side in FIG. 2;

FIG. 4 is a cross-sectional view illustrating a comparative example; and

FIG. 5 is a cross-sectional view illustrating another embodiment.

### BEST MODE FOR CARRYING OUT THE INVENTION

### First Embodiment

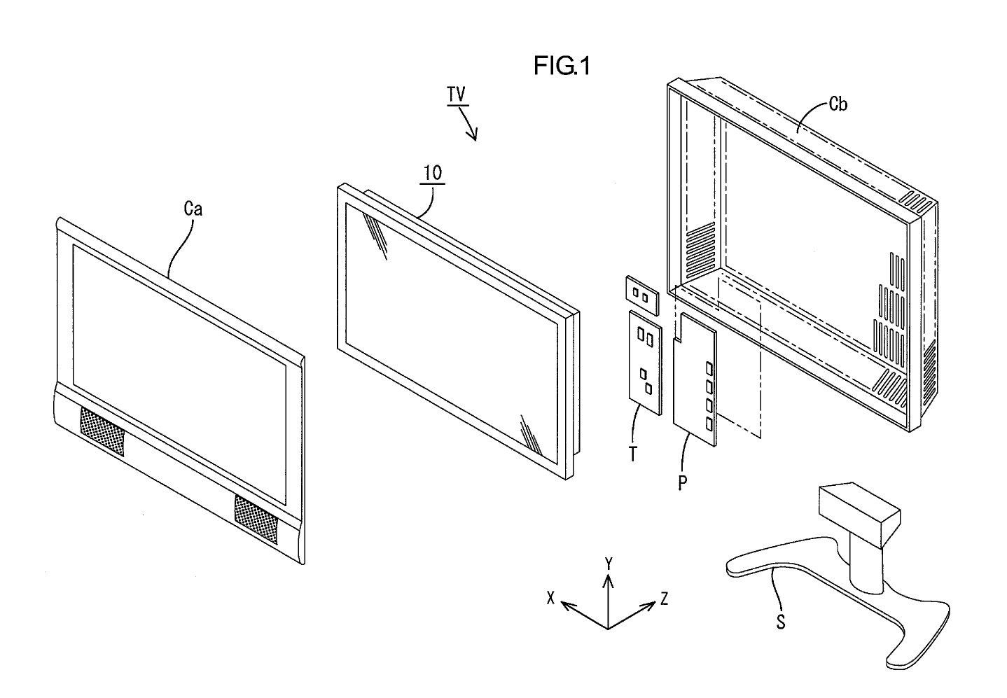

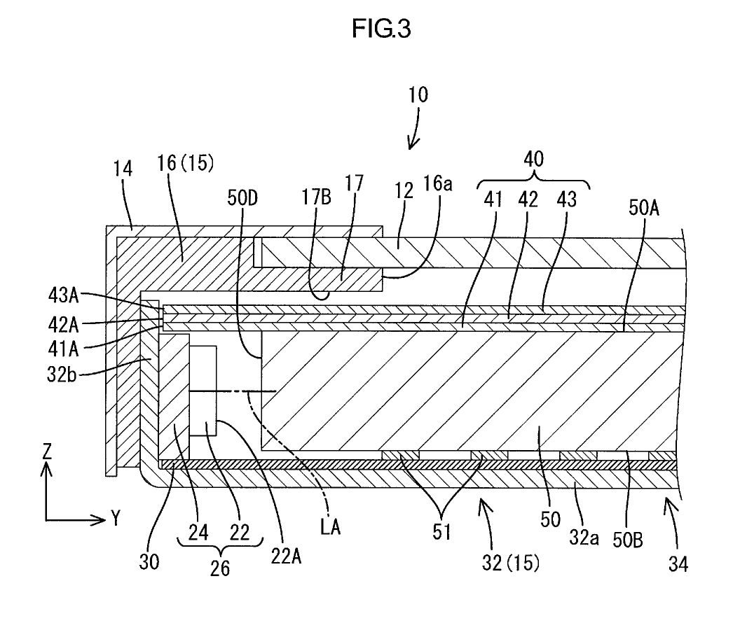

A first embodiment of the present invention will be described with reference to FIGS. 1 to 4. An X-axis, a Y-axis and a Z-axis are described in a part of the drawings. The axes in each drawing correspond to the respective axes in other drawings. An upper side in FIG. 3 corresponds to a front side and a lower side in FIG. 3 corresponds to a rear side.

As illustrated in FIG. 1, a television receiver TV of the present embodiment includes a liquid crystal display device 10, front and rear cabinets Ca, Cb which house the liquid crystal display device 10 therebetween, a power source P, a tuner T, and a stand S.

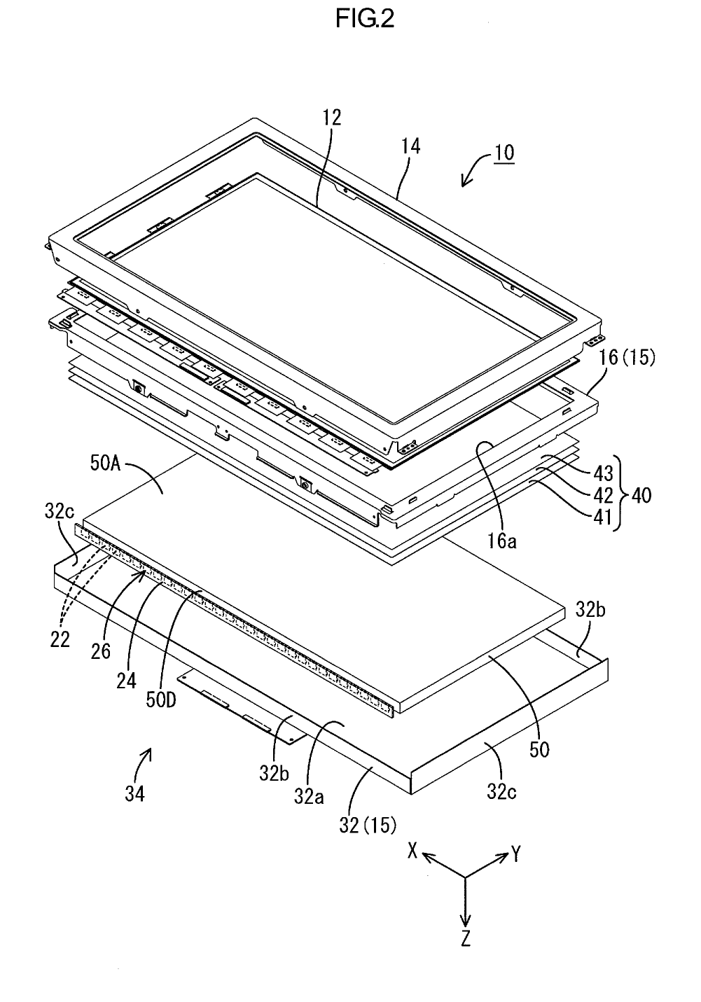

FIG. 2 illustrates the liquid crystal display device 10 in an exploded perspective view. An upper side in FIG. 2 corresponds to a front side and a lower side in FIG. 2 corresponds to a rear side. As illustrated in FIG. 2, an entire shape of the liquid crystal display device 10 is a landscape rectangular. The liquid crystal display device 10 includes a liquid crystal panel 11 as a display panel, and a backlight device 34 as an external light source. The liquid crystal panel 11 and the backlight device 34 are integrally held by a frame shaped bezel 14 or the like.

As illustrated in FIG. 2, the liquid crystal panel 12 included in the liquid crystal display device 10 has a rectangular shape in a plan view. A long side of the liquid crystal display device 10 matches a horizontal direction (an X-axis direction) and a short side thereof matches a vertical direction (Y-axis direction). The liquid crystal panel 12 is configured such that a pair of transparent (high light transmissive) glass substrates is bonded together with a predetermined gap therebetween and liquid crystal layer (not illustrated) is sealed between the glass substrates. On one of the glass substrates, switching components (for example, TFTs) connected to source lines and gate lines which are perpendicular to each other, pixel electrodes connected to the switching components, and an alignment film and the like are provided. On the other glass substrate, color filters having color sections such as red (R), green (G) and blue (B) color sections arranged in a predetermined pattern, counter electrodes, and an alignment film and the like are provided. Image data and control signals that are required to display an image are sent to the source lines, the gate lines, and the counter electrodes, from a drive circuit substrate, which is not illustrated. Polarizing plates (not illustrated) are arranged on outer surfaces of the glass substrates.

Next, the backlight unit 34 will be explained. As illustrated in FIG. 2, the backlight unit 34 includes a housing member 15 including a backlight chassis 32 and a front chassis 16. The housing member 15 houses an LED unit 26, a light guide plate 50, and an optical member 40 therein. The backlight unit 34 according to the present embodiment is an edge light type (side light type) backlight unit in which the light guide plate 50 is arranged right behind the liquid crystal panel 12, and LEDs 22 (light source) are arranged on a side end portion of the light guide plate 50.

The backlight chassis 32 has a substantially box-like shape with an opening on the front side (a light exit side, the liquid crystal panel 12 side). The optical member 40 is arranged so as to cover the opening of the backlight chassis 32. The front chassis 16 has a rectangular frame shape having an opening 16a through which the optical member 40 is exposed to the front side. The front chassis 16 is arranged so as to enclose the optical member 40 in a plan view. As illustrated in FIG. 3, on an inner peripheral end portion of the front chassis 16, a stepped portion 17 is provided. A peripheral edge portion of the liquid crystal panel 12 is placed on the stepped portion 17. With this configuration, the light exiting from the light guide plate 50 passes through the optical member 40, and then is applied to a rear surface of the liquid crystal panel 12 through the opening 16a.

The backlight chassis 32 is made of metal such as an aluminum material. The backlight chassis 32 includes a bottom plate 32a having a rectangular shape in a plan view, and side plates 32b, 32c each of which rises from an outer edge of the corresponding long or short sides of the bottom plate 32a toward the front side. The long side of the bottom plate 32a matches a horizontal direction (X-axis direction) and the short side thereof matches a vertical direction (Y-axis direction). On a rear surface of the bottom plate 32a, a power circuit board (not illustrated) that supplies power to the LED unit 26 is attached, for example.

The LED unit 26 is attached to an inner surface of one of the side plates 32b of the backlight chassis 32 that extends along the long-side direction (X-axis direction) with screws, for example. As illustrated in FIG. 2, the LED unit 26 includes an LED board 24 (a light source board) having a rectangular shape extending along the X-axis direction and the LEDs 22 (Light Emitting Diodes) arranged on the LED board 24 in a straight line. The LEDs 22 are configured to emit white light.

As illustrated in FIG. 3, the LED 22 is arranged such that a light axis LA thereof extends along the direction parallel to a display surface of the liquid crystal panel 12 or a light exit surface 50A of the light guide plate 50 (Y-axis direction). A light emitting surface 22A of the LED 22 faces a side surface (light entrance surface 50D) of the light guide plate 50. The LED board 24 to which a base end section of the LED 22 is attached is located farther from the light guide plate 50 than the light emitting surface 22A of the LED 22. The light emitted from the LED 22 (light emitting surface 22A) radiates three-dimensionally around the light axis LA within a specified angle range and the directivity thereof is higher than that of cold cathode tubes. Namely, angle distributions of the LED 22 show a tendency that the emission intensity of the LED 22 is significantly high along the light axis LA and sharply decreases as the angle to the light axis LA increases.

The LED 22 is configured by sealing LED chips as light emitting elements onto a housing with a resin material. For example, the LED 22 includes three different kinds of LED chips each having a different main emission wavelength. Specifically, each of the LED chips emits a single color of light of red (R), green (G) or blue (B). The LED 22 is not limited to the above configuration, and may have another configuration. The LED 22 may only include an LED chip that is configured to emit light in a single color of blue (B) and covered with a resin containing a phosphor having a light emitting peak in a red (R) range and a phosphor having a light emitting peak in a green (G) range, for example, silicon. Alternatively, the LED 22 may include an LED chip that is configured to emit light in a single color of light of blue (B) and covered with a resin containing a YAG phosphor that emits yellow light, for example, silicon.

The LED board 24 is made of synthetic resin. Surfaces (including a surface facing the light guide plate 50) of the LED board 24 have a white color that provides high light reflectivity. As illustrated in FIG. 2, the LED board 24 has a rectangular plate shape extending along the X-axis direction. The long side of the LED board 24 is slightly shorter than (or substantially the same as) that of the bottom plate 32a. Further, mounting holes (not illustrated) that are through holes are formed in the bottom plate 32a to fix the LED board 24 with screws.

A wiring pattern (not illustrated) made of metal film is provided on the LED board 24 and the LEDs 22 are mounted on predetermined positions of the LED board 24. A control board, which is not illustrated, is connected to the LED board 24. The control board supplies the power required to turn on the LEDs 22 and controls the drive of the LEDs 22.

The light guide plate 50 is a plate-like member having a rectangular shape in a plan view. The long side of the light guide plate 50 extends along the long-side direction (the X-axis direction) of the backlight chassis 32. The light guide plate 50 is made of a resin such as acrylic that has a high light transmission (high transparency). As illustrated in FIG. 2, the light guide plate 50 is arranged such that amain plate surface (a light exit surface 50A) thereof faces toward the liquid crystal panel 12 and one of side surfaces (a light entrance surface 50D) faces the light emitting surface 22A of the LED 22. The shape of the light guide plate 50 is not limited to the rectangular shape in a plan view, and may be any other shapes.

A plurality of light reflective portions 51 are provided on a surface 50B (a rear surface 50B) of the light guide plate 50 that is opposite from the light exit surface 50A. The light reflective portions 51 are arranged in a dotted pattern having a white color. The light reflective portions 51 are configured to reflect and scatter the light. Accordingly, some of the rays of light that travel toward the light exit surface 50A after being reflected and scattered by the light reflective portions 51 has an entrance angle that is not above the critical angle (some of the rays of light are not reflected), and thus the light can exit toward the liquid crystal panel 12 through the light exit surface 50A. The light reflective portions 51 are, for example, configured by arranging the dots in a zigzag pattern (grid pattern, staggered pattern). The dots are formed by printing metal oxide pastes on the rear surface 50B of the light guide plate 50, for example. Preferable examples of the printing method of the dots include screen printing and ink-jet printing.

With the above configuration, the light emitted from the light emitting surface 22A of each LED 22 enters the light guide plate 50 through the light entrance surface 50D of the light guide plate 50, and then is guided within the light guide plate 50 due to the total reflection and is reflected and scattered by the light reflective portion 51. Thus, the light exits from the light exit surface 50A. Then, the light exiting from the light exit surface 50A is applied to the rear surface of the liquid crystal panel 12 after passing through the optical member 40. The light reflective portions 51 are provided on an area corresponding to the opening 16a of the front chassis 16 (an area overlapping with the opening 16a in a plan view), for example.

A light reflection sheet 30 is arranged on the bottom plate 32a of the backlight chassis 32. The light reflection sheet 30 is arranged so as to cover almost entire of the rear surface 50B of the light guide plate 50 and a rear surface of the LED unit 26. The light reflective sheet 30 is made of a synthetic resin, for example, and includes a front surface having a white color that provides high light reflectivity. The light exiting from the light guide plate 50 to the light reflective sheet 30 is reflected again toward the light exit surface 50A by the light reflective sheet 30. This improves light use efficiency. The light reflective sheet 30 also has a function of reflecting the light that is emitted from the LED 22 to the light reflective sheet 30 so as to enter the light entrance surface 50D of the light guide plate 50. The material and color, for example, of the light reflective sheet 30 are not limited to those of the present embodiment. Any light reflective sheets that can reflect the light may be used.

The optical member 40 is arranged so as to cover the front surface of the light exit surface 50A of the light guide plate 50. The optical member 40 includes a light diffuser sheet 41 (a light diffuser member), a prism sheet 42, and a reflection-type polarizing sheet 43 arranged in this sequence from the light exit surface 50A side. The light diffuser sheet 41 may be configured by bonding a diffusion layer including light scattering particles dispersed therein onto a front surface of a light transmissive board made of synthetic resin. The light diffuser sheet 41 diffuses the light that exits from the light exit surface 50A. The prism sheet 42 controls the traveling direction of the light that passed through the light diffuser sheet 41.

The reflection-type polarizing sheet 43 has a multilayer structure in which layers having different reflective indexes are alternately arranged, for example. The reflection-type polarizing sheet 43 transmits p-wave of the light exiting through the light exit surface 50A and reflects s-wave toward the light guide plate 50. The s-wave reflected by the reflection-type polarizing sheet 43 is reflected again toward the front side by the light reflection sheet 30, for example. At this time, the reflected s-wave separates into s-wave and p-wave. As described above, the reflection-type polarizing sheet 43 allows the s-wave that is normally absorbed by the polarizing plate of the liquid crystal panel 12 to be reused by reflecting the s-wave toward the light guide plate side. This improves light use efficiency (and thus brightness). An example of the reflection-type polarizing sheet 43 is a product named “DBEF” that is manufactured by Sumitomo 3M Limited.

As illustrated in FIG. 2, like the light guide plate 50, each of the light diffuser sheet 41, the prism sheet 42, and the reflection-type polarizing sheet 43 has a rectangular shape extending along the X-axis direction in a plan view. The light diffuser sheet 41, the prism sheet 42, and the reflection-type polarizing sheet 43 have the same shape. Each of the sheets 41 to 43 has a short side (measured in the Y-axis direction) that is longer than the short side (measured in the Y-axis direction) of the light guide plate 50. The shape of the sheets 41 to 43 included in the optical member 40 is not limited to the rectangular shape in a plan view.

As illustrated in FIG. 3, an LED-side end portion of the respective sheets 41 to 43 included in the optical member 40 protrudes toward a side away from the light guide plate 50 (the left side in FIG. 3) so as to overlap with the LED board 24 and the LED 22 in a plan view. Accordingly, the LED-side side surfaces 41A to 43A of the sheets 41 to 43 face an inner surface of the side plate 32b (a surface on the right in FIG. 3), on which the LED unit 26 is mounted, with a small gap therebetween. The LED-side side surfaces 41A to 43A of the sheets 41 to 43 do not necessarily overlap with the LED board 24 in a plan view as long as the LED-side surfaces 41A to 43A of the sheets 41 to 43 are located farther from the light guide plate 50 than the light emitting surface 22A of the LED 22.

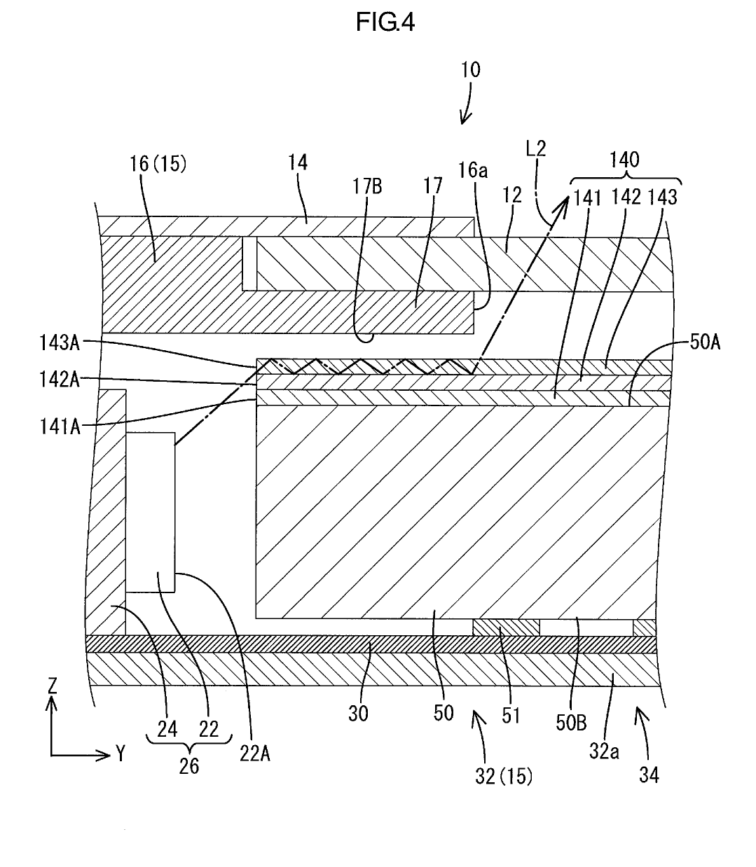

Next, advantages obtained by the present embodiment will be explained. First, with reference to FIG. 3 and FIG. 4, an advantage obtained by the configuration in which the LED-side side surfaces 41A to 43A of the sheets 41 to 43 are located farther from the light guide plate 50 than the light emitting surface 22A of the LED 22 will be explained. A comparative example is illustrated in FIG. 4 to clarify this advantage. In the configuration in FIG. 4, the LED-side side surface 141A to 143A of the sheets 141 to 143 included in the optical member 140 are located closer to the light guide plate (on the right side in FIG. 4) than the light exit surface 50A of the LED 22.

In the configuration in FIG. 4, some of the rays of light emitted from the LED 22 (indicated by an arrow L2 in FIG. 4) may reach the front side of the light exit surface 50A. In such a case, the rays of light enter the optical member 140 through the side surfaces 141A to 143A of the optical member 140. Among those rays of light, the rays of light L2 entering the reflection-type polarizing sheet 143 included in the optical member 140 through the LED-side side surface 143A will be explained as an example.

The light L2 that entered through the LED-side side surface 143A of the reflection-type polarizing sheet 143 is repeatedly totally reflected within the reflection-type polarizing sheet 143 and guided toward the inner side of the backlight unit 34 (the right side in FIG. 4). The light L2 guided toward the inner side may exit toward the front side from the reflection-type polarizing sheet 143 at an area corresponding to the opening 16a of the front chassis 16 in some cases. This increases the brightness on the area of the light exit surface of the backlight unit 34 from which the light L2 exits (the area corresponding to the opening 16a of the front chassis 16 in a plan view). Thus, uneven brightness is likely to occur.

Although the light L2 entering through the side surface 143A of the reflection-type polarizing sheet 143 was described above, the same will occur (the light will be guided in the sheet and exit locally) when the light enters through the side surface 141A, 142A of the light diffuser sheet 141 or the prism sheet 142.

In view of the above, in the backlight unit 34 of the present embodiment, the LED-side side surface 41A to 43A of the sheets 41 to 43 are located farther from the light guide plate 50 than the light emitting surface 22A of the LED 22. With this configuration, the light emitted from the light emitting surface 22A of the LED 22 may not enter the side surfaces 41A to 43A of the sheets 41 to 43 included in the optical member 40. Accordingly, the light entered in the sheets 41 to 43 from the side surface 41A to 43A of the sheet 41 to 43 is less likely to be guided in the sheets 41 to 43. This suppresses that the light guided in the sheets 41 to 43 exits locally from the light exit surface of the backlight unit 34. Thus, uneven brightness is less likely to occur.

The present embodiment employs LED 22 as a light source. The employment of the LED 22 reduces power consumption.

The present invention is not limited to the embodiments explained in the above description with reference to the drawings. The following embodiments may be included in the technical scope of the present invention, for example.

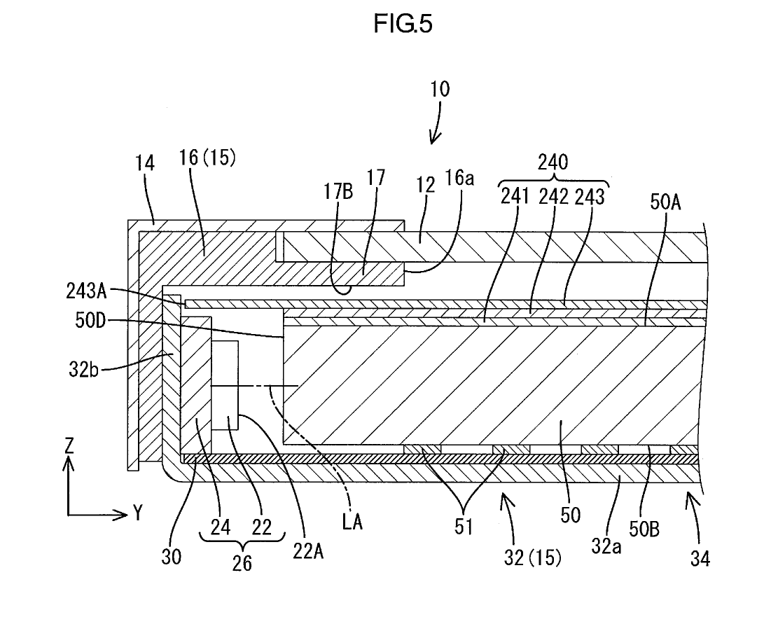

(1) In the above embodiment, the side surfaces 41A to 43A of the sheets 41 to 43 included in the optical member 40 are located farther from the light guide plate 50 than the light emitting surface 22A of the LED 22, but the present invention is not limited to the above embodiment. At least one of the side surfaces 41A to 43A of the sheets 41 to 43 may be located farther from the light guide plate 50 than the light emitting surface 22A of the LED 22. For example, as illustrated in FIG. 5, the side surface of one of the sheets 241 to 243 (the side surface 243A of the reflection-type polarizing sheet 243 in FIG. 5) included in the optical member 240 may be located farther from the light guide plate 50 than the light emitting surface 22A of the LED 22.

(2) The optical member 40 is not limited to the above configuration. The optical member 40 may or may not include the above sheets, and the number of such sheet may be suitably determined. The optical member 40 may include a diffuser plate (a light diffuser member) and a lens sheet, for example. An LED-side side surface of such sheets may be located farther from the light guide plate 50 than the light emitting surface 22A of the LED 22. The aspect of the present invention may employ any optical member that can guide the light therein. The LED-side side surface of the optical member is located farther from the light guide plate 50 than the light emitting surface 22A of the LED 22.

(3) In the above embodiments, the LED unit 26 is provided on only one of the side plates 32b, 32c of the backlight chassis 32, but may be provided on two or more of the side plates 32b, 32c. In such a case, each of the side surfaces of the optical members 40 that is close to the LED unit 26 (LED 22) is located farther from the light guide plate 50 than the light emitting surface 22A of the corresponding light emitting surface 22A of the LEDs 22.

(4) In the above embodiments, the LED 22 is used as a light source, but light sources other than LED may be used.

(5) In the above embodiments, TFTs are used as switching components of the liquid crystal display device. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(6) In the above embodiments, the liquid crystal display device including the liquid crystal panel as a display panel is used. The technology can be applied to display devices including other types of display panels.

(7) In the above embodiments, the television receiver including the tuner is used. However, the technology can be applied to a display device without a tuner.

### EXPLANATION OF SYMBOLS

10: liquid crystal display device (display device), 12: liquid crystal panel (display panel), 22: LED (light source, light emitting diode), 22A: light emitting surface, 24: LED board (light source board), 34: backlight device (lighting device), 40, 240: optical member, 41: light diffuser sheet (light diffuser member), 41A: side surface of light diffuser sheet (light-source-side side surface of the optical member), 42: prism sheet, 42A: side surface of prism sheet (light-source-side side surface of the optical member), 43: reflection-type polarizing sheet, 43A, 243A: side surface of reflection-type polarizing sheet (light-source-side side surface of the optical member), 50: light guide plate, 50A: light exit surface, 50D: light entrance surface, TV: television receiver

1. A lighting device comprising:
a light source having a light emitting surface;
a light guide plate having a light entrance surface and a light exit surface, the light entrance surface facing the light emitting surface of the light source and through which light emitted from the light source enters the light guide plate, the light exit surface through which the light in the light guide plate exits; and
an optical member covering the light exit surface,
wherein the optical member is arranged such that a light-source-side side surface of the optical member is located farther from the light guide plate than the light emitting surface of the light source.

2. The lighting device according to claim 1, further comprising a light source board on which the light source is mounted, wherein:
the light source board is located farther from the light guide plate than the light emitting surface of the light source; and
the optical member is arranged such that a light-source-side end portion of the optical member overlaps with the light source board in a plan view.

3. The lighting device according to claim 1, wherein the optical member includes a light diffuser member.

4. The lighting device according to claim 1, wherein the optical member includes a prism sheet.

5. The lighting device according to claim 1, wherein the optical member includes a reflection-type polarizing sheet.

6. The lighting device according to claim 1, the light source is a light emitting diode.

7. A display device comprising:
the lighting device according to claim 1; and
a display panel configured to provide display using light emitted from the lighting device.

8. The display device according to claim 7, wherein the display panel is a liquid crystal panel using liquid crystals.

9. A television receiver comprising the display device according to claim 7.
